(19) United States
(12) Patent Application Publication
(10) Pub. No.: US 2015/0339782 A1
(43) Pub. Date: Nov. 26, 2015

(54) SYSTEM AND METHOD FOR CLASSIFYING A PLURALITY OF CUSTOMER ACCOUNTS

(71) Applicant: Tata Consultancy Services Limited, Mumbai (IN)

(72) Inventors: Dipti Mohan FONDEKAR, Mumbai (IN); Mahesh KSHIRSAGAR, Mumbai (IN); Dwarika Nath MISHRA, Mumbai (IN); Rajashree DAS, Mumbai (IN); Vikram POLAVARAPU, Mumbai (IN)

(21) Appl. No.: 14/719,454

(22) Filed: May 22, 2015

(30) Foreign Application Priority Data
May 26, 2014 (IN) 1751/MUM/2014

(51) Int. Cl. G06Q 40/00; G06F 17/30

(52) U.S. Cl. CPC G06Q 40/12; G06F 17/30342; G06F 17/30598

(57) ABSTRACT

Disclosed is a method and system for classifying a plurality of customer accounts based on a recoverable amount from a customer account. The method includes receiving historical data of the customer account and a user input indicating a selection of a predictive analytics algorithm from a set of predictive analytics algorithms, and building a predictive data model by executing the predictive analytics algorithm on the historical data. The building includes computing a contact index for the customer account and a payment index for the customer account. The building further includes computing a recoverability index based on the contact index, the payment index, and the outstanding amount. The recoverability index denotes the recoverable amount. The method further includes classifying the customer account based on the recoverability index.

### CROSS REFERENCE TO RELATED APPLICATIONS

The present application claims priority to Indian Patent Application No. 1751/MUM/2014 filed on May 26, 2014, the entirety of which is hereby incorporated by reference.

### TECHNICAL FIELD

The present subject matter described herein generally relates to classification of a plurality of customer accounts, and more particularly to classification of the plurality of customer accounts based on a recoverable amount from a customer account.

### BACKGROUND

The process of debt collection and recovery is a tedious and time consuming task due to a high rate of defaults in payment of debt by customers. Collection agents or recovery agents invest vast amounts of time analyzing historical data of each customer account in order to identify the customers to be targeted for recovery of an amount due from each customer. As the pool of customer accounts is large, the historical data to be analyzed also increases exponentially.

Currently, the historical data is analyzed manually to prioritize the customer accounts for debt collection or recovery. The historical data includes only past payment history that is used to identify the customer accounts with a high risk score or a low risk score. Moreover, the historical data is not stored in a structured or organized manner. Therefore, analyzing the historical data to identify the customer set to be targeted is a highly complex and time consuming task.

### SUMMARY

This summary is provided to introduce aspects related to system(s) and method(s) for classifying a plurality of customer accounts based on a recoverable amount from a customer account and the aspects are further described below in the detailed description. This summary is not intended to limit the scope of the claimed subject matter.

In one implementation, a method for classifying a plurality of customer accounts based on a recoverable amount from a customer account of the plurality of customer accounts is disclosed. The method includes receiving, by a processor, historical data of the customer account and a user input indicating a selection of a predictive analytics algorithm from a set of predictive analytics algorithms. The method further includes building, by the processor, a predictive data model by executing the predictive analytics algorithm on the historical data. The building includes computing a contact index for the customer account, wherein the contact index denotes a probability of an accountholder of the customer account getting contacted by a user, and computing a payment index for the customer account, wherein the payment index denotes the probability of the account holder paying the recoverable amount from an outstanding amount of the customer account. The building further includes computing a recoverability index based on the contact index, the payment index, and the outstanding amount, wherein the recoverability index denotes the recoverable amount. The method further includes classifying, by the processor, the customer account based on the recoverability index.

In one implementation, a system for classifying a plurality of customer accounts based on a recoverable amount from a customer account of the plurality of customer accounts is disclosed. The system includes a processor and a memory coupled to the processor for executing a plurality of modules present in the memory. The plurality of modules includes a receiving module, a building module, and a classifying module. The receiving module receives historical data of the customer account and a user input indicating a selection of a predictive analytics algorithm from a set of predictive analytics algorithms. The building module builds a predictive data model by executing the predictive analytics algorithm on the historical data. The building module includes a computing module. The computing module computes a contact index for the customer account, wherein the contact index denotes a probability of an account holder of the customer account getting contacted by a user, and a payment index for the customer account, wherein the payment index denotes the probability of the account holder paying the recoverable amount from an outstanding amount of the customer account. The computing module further computes a recoverability index based on the contact index, the payment index, and the outstanding amount, wherein the recoverability index denotes the recoverable amount. The classifying module classifies the customer account based on the recoverability index.

In one implementation, a non-transitory computer readable medium embodying a program executable in a computing device for classifying a plurality of customer accounts based on a recoverable amount from a customer account of the plurality of customer accounts is disclosed. The program includes a program code for receiving historical data of the customer account and a user input indicating a selection of a predictive analytics algorithm from a set of predictive analytics algorithms. The program further includes a program code for building a predictive data model by executing the predictive analytics algorithm on the historical data. The program code for building includes a program code for computing a contact index for the customer account, wherein the contact index denotes a probability of an accountholder of the customer account getting contacted by a user. The program code for building further includes a program code for computing a payment index for the customer account, wherein the payment index denotes the probability of the account holder paying the recoverable amount from an outstanding amount of the customer account; and a program code for computing a recoverability index based on the contact index, the payment index, and the outstanding amount, wherein the recoverability index denotes the recoverable amount. The program further includes a program code for classifying the customer account based on the recoverability index.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for classifying a plurality of customer accounts based on a recoverable amount from a customer account is shown, in accordance with an embodiment of the present subject matter.

FIG. 2 illustrates the system, in accordance with an embodiment of the present subject matter.

FIG. 3 illustrates a method for computing a contact index, in accordance with an embodiment of the present subject matter.

FIG. 4 illustrates a method for classifying a plurality of customer accounts based on a recoverable amount from a customer account, in accordance with an embodiment of the present subject matter.

### DETAILED DESCRIPTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various drawings. Systems and methods for classifying a plurality of customer accounts are described. The present subject matter discloses an efficient mechanism for classifying the plurality of customer accounts based on a recoverable amount from a customer account. In order to classify the plurality of customer accounts historical data of the customer account may be used. The historical data may comprise collection data of an outstanding amount, payments for the customer account, and transactions for the customer account.

Further, a user input indicating a selection of a predictive analytics algorithm from a set of predictive analytics algorithms may be used for classifying the plurality of customer accounts. Subsequent to receipt of the historical data and the predictive analytics algorithm, a predictive data model may be built by executing the predictive analytics algorithm on the historical data.

In order to build the predictive data model a contact index for the customer account and a payment index for the customer account may be computed. The contact index denotes a probability of an account holder of the customer account getting contacted by a user. The payment index denotes the probability of the account holder paying the recoverable amount from an outstanding amount of the customer account. Further, a recoverability index may be computed based on the contact index, the payment index, and the outstanding amount. The recoverability index denotes the recoverable amount. Further, the customer account may be classified based on the recoverability index.

While aspects of described system and method for classifying a plurality of customer accounts based on a recoverable amount from a customer account may be implemented in any number of different computing systems, environments, and/or configurations, the embodiments are described in the context of the following exemplary system.

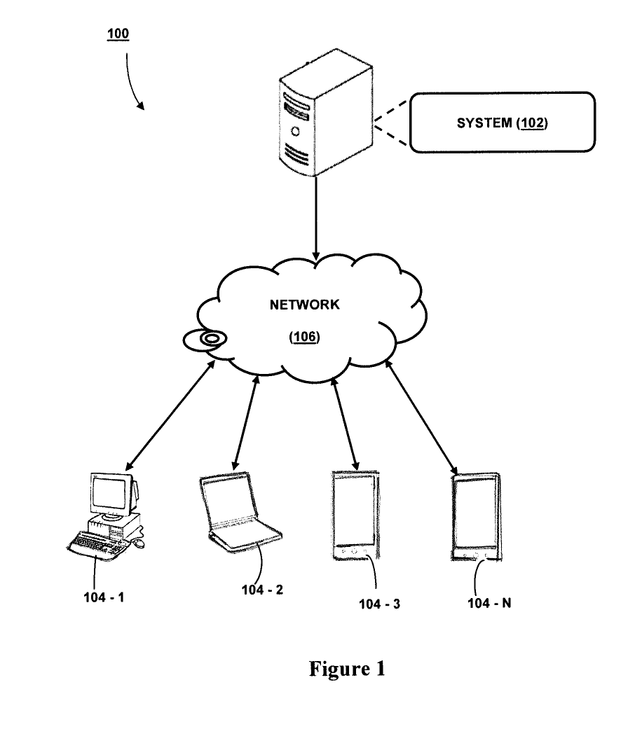

Referring now to FIG. 1, a network implementation 100 of a system 102 for based on a recoverable amount from a customer account is illustrated, in accordance with an embodiment of the present subject matter. In one embodiment, the system 102 provides for classification of a plurality of customer accounts based on a recoverable amount from a customer account. At first, historical data of the customer account and a user input indicating a selection of a predictive analytics algorithm from a set of predictive analytics algorithms may be received. After receiving the historical data and the predictive analytics algorithm, the system 102 may build a predictive data model by executing the predictive analytics algorithm on the historical data. In one embodiment, the system 102 may compute a contact index, a payment index, and a recoverability index for the customer account. Further, based on the recoverability index the system 102 may classify the customer account.

Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, and the like. In one implementation, the system 102 may be implemented in a cloud-based environment. It will be understood that the system 102 may be accessed by multiple users through one or more user devices 104-1, 104-2, 104-3, and 104-N, collectively referred to as user devices 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

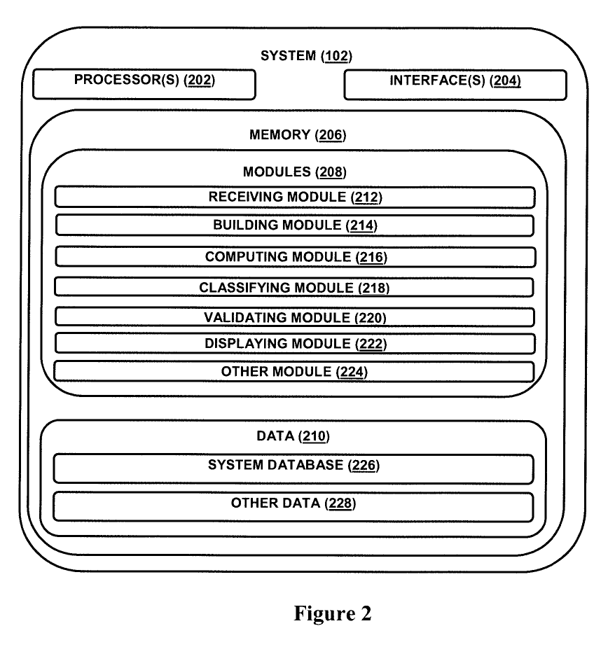

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the media system 102 to interact with a user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks, functions or implement particular abstract data types. In one implementation, the modules 208 may include a receiving module 212, a building module 214, a computing module 216, a classifying module 218, a validating module 220, a displaying module 222, and other modules 224. The other modules 224 may include programs or coded instructions that supplement applications and functions of the system 102.

The data 210, amongst other things, serves as a repository for storing data processed, received, and generated by one or more of the modules 208. The data 210 may also include a system database 226, and other data 228. The other data 228 may include data generated as a result of the execution of one or more modules in the other modules 224.

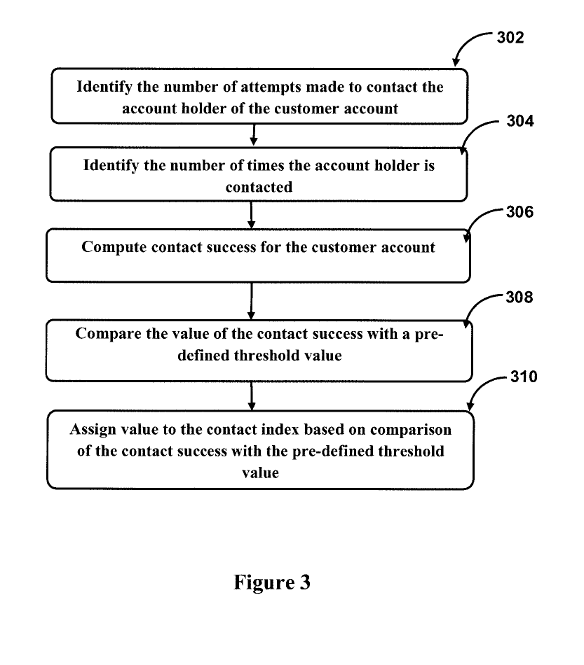

In one implementation, at first, a user may use the client device 104 to access the system 102 via the I/O interface 204. The user may register themselves using the I/O interface 204 in order to use the system 102. The working of the system 102 may be explained in detail in FIG. 3 explained below. The system 102 may be used for classifying a plurality of customer accounts based on a recoverable amount from a customer account of the plurality of customer accounts. In order to classify the plurality of customer accounts, the system 102, at first, receives historical data of the customer account. Specifically, in the present implementation, the historical data is received by the receiving module 212.

The historical data may include collection data for the customer account. The collection data may include customer contact information, payment information, and settlement information of the customer account. The customer contact information may include contact number of the customer, address of the customer, and number of follow-ups made with the customer. Further, the payment information may include historical payments made by the customer any time between last payment cycle, or in last 3-5 years. Further, the historical data received by the receiving module 212 may be stored in the system database 226.

In another implementation of the system 102, the historical data may be data related to closed cases of the plurality of customer accounts. For example, the closed cases may include cases which are settled, or the cases for which the customer has furnished the entire recoverable amount.

In one implementation, the receiving module 212 may further receive a user input indicating a selection of a predictive analytics algorithm from a set of predictive analytics algorithms. The set of predictive analytics algorithm may include a supervisory predictive analytics algorithm, and a non-supervisory algorithm.

The receiving module 212 may further receive a user input including a data field selected from a set of data fields. The set of data fields may capture data related to the account holder. For example, the set of data fields may include gender, age, address, locality, occupation, employment, marital status, income, home phone, and mobile phone of the account holder. Further, the receiving module 212 may receive a value or a value range, and weightage for the data field selected.

In one implementation, the data field may be selected by the user from the set of data fields. Similarly, the value or the value range, and the weightage received by the receiving module 212 may be assigned by the user for the data field.

TABLE 1

| Sr. No. | Data field | Value/Value Range |
|---|---|---|
| 1 | Gender | Male (M)/Female (F) |
| 2 | Age | 1-25, 25-50, 50-99 |
| 3 | Address line 1 to 4 | Available indicator Yes/No |
| 4 | Locality | Area of the pin code |
| 5 | Occupation | Doctor, Lawyer, Teacher, IT Engineer |
| 6 | Employment | Student, Private Service, Government |
| | | Service, Armed Forces |
| 7 | Marital Status | Single, married, widow, separated |
| 8 | Income | 0-3 lakhs p.a., 3-8 lakhs p.a. |
| 9 | Home phone | Available indicator Yes/No |
| 10 | Mobile Phone | Available indicator Yes/No |

Table 1 illustrates an example for the set of data fields with corresponding value or value ranges. For example, the value for gender may be M/F. The value range for the data field, age, may be 1-25, 25-50, or 50-99. Similarly, for the data field, address line, the value may be Yes, or No depending upon availability of an address for the customer account. Further, for the data field, locality, the value may be a pin code of the locality in which the account holder of the customer account resides. The value for the data field, occupation, may be doctor, lawyer, teacher, or engineer.

Similarly, the value for the data field employment may be student, private service, government service, or armed forces. The marital status may be single, married, widow, or separated. Further, the value range for income may be 0-3 lakhs p.a., 3-8 lakhs p.a., or 8-10 lakhs p.a. The value or value ranges for the set of data fields may be configured and modified by the user in the system database 226. Further, the weightage for the data field received by the receiving module 212 may be in a range of 0.1 to 1.0. For example, the user may assign the weightage of 0.1 for age.

The system 102 further comprises the building module 214. The building module 214 may build a predictive data model by executing the predictive analytics algorithm on the historical data. The predictive analytics algorithm may be the supervisory predictive analytics algorithm, and the non-supervisory algorithm. For example, the CART algorithm, or KNN algorithm or Logistic Regression algorithm may be used for building the predictive data model. The predictive data model predicts a probability of an account holder of the customer account getting contacted, and the probability of the account holder paying the recoverable amount from an outstanding amount.

In another implementation of the system 102, the predictive data model may be further built based on the value or the value range, and the weightage for the data field. For example the predictive analytics algorithm may use the value or the value range, and weightage for the data filed as an input data set to build the predictive data model.

In one implementation, the building module 214 comprises the computing module 216. The computing module 216 may compute a contact index for the customer account. The contact index denotes the probability of the account holder of the customer account getting contacted by a user. For example, if the contact index is 0.63, then 0.63 denotes that there is a 63% probability of the account holder getting contacted.

The computing module 216 may further compute a payment index for the customer account. The payment index denotes the probability of the account holder paying the recoverable amount from an outstanding amount of the customer account. For example, if the payment index is 0.67, then 0.67 denotes that there is 67% probability of the account holder paying the recoverable amount from the outstanding amount.

Further, the computing module 216 may compute a recoverability index based on the contact index, the payment index, and the outstanding amount. The recoverability index may be computed as, recoverability index=(outstanding amount*contact index*payment index). The recoverability index denotes the recoverable amount. The recoverable amount denotes an actual amount that can be recovered from the outstanding amount. For example, consider that for a customer account, the outstanding amount is Rs. 50,00,000. Though the outstanding amount is Rs. 50, 00,000, the recoverable amount may be different from the outstanding amount. The recoverable amount is represented by the recoverability index, as the recoverability index is computed based on the contact index and the payment index. For example, for the above outstanding amount of Rs. 50,00,000, the recoverability index may be 0.50 and the recoverable amount may be 25,00,000.

In an exemplary implementation of the system 102, FIG. 3 illustrates computation of the contact index for the customer account using the historical data. Consider that the historical data received by the receiving module 212 comprises trail records of attempts made to contact the account holder of the customer account. At step 302, the number of attempts made to contact the account holder (A) may be identified. The number of attempts made to contact the account holder may be identified by counting the trail records, when “Follow-up code < >‘SI’” (Settlement Invalidation) and “Follow-up code < >[blank]” and “Excuse Code < >[blank]” for the customer account. Excuse code is a code given based on interaction with the account holder for not making the payment. For example, the excuse code may comprise ‘W—Illness’, ‘Y—Does not understand Terms & Conditions’ and ‘V—Refinancing loans’. At step 304, the number of times the account holder is contacted (B) from the number of attempts made (A), may be identified. The number of times the account holder is contacted (B) may be identified by checking a ‘Party Contact Code’. The ‘Party Contact Code’ denotes if the account holder of the customer account is contacted successfully. For example, consider that the ‘Party Contact Code=‘A’” denotes that the account holder of the customer account is contacted successfully. Thus, when the ‘Party Contact Code=‘A’, a count of the number of times the account holder is contacted (B) may be incremented.

Still referring to FIG. 3, at step 306, ‘Contact Success (C)’ for the customer account may be computed. The ‘Contact Success (C)’ may be computed as, number of times the account holder is contacted (B)/number of attempts (A). Further, at step 308, the computing module 216 may compare the value of the ‘Contact Success (C)’ with a pre-defined threshold value. The pre-defined threshold value may be configured by the user. For example, consider that the pre-defined threshold value is 0.5. At step 310, the contact index may be assigned value ‘1’ when the ‘Contact Success’ >=0.5. Further, the contact index may be assigned value ‘0” when the ‘Contact Success’<0.5. In another implementation, the contact index may be assigned value ‘Yes’ when the ‘Contact Success’ >=0.5. Similarly, the contact index may be assigned value ‘No’ when the ‘Contact Success’<0.5.

Further, for computation of the contact index the trail records of closed cases may be considered. Alternatively, the trail records for the last month may be used to compute the contact index. In another implementation, the contact index may be computed as a weighted average of the contact index computed using the trail records of closed cases (Historic Contact Index), and the contact index computed using the trail records for the last month (Recent Contact Index). The ‘Recent Contact Index’ may be assigned a higher weightage than the ‘Historic Contact Index’. The ‘Recent Contact Index’ may be assigned the higher weightage as the ‘Recent Contact Index’ reflects a recent activity of the customer account. The contact index may be computed as, Contact Index=[w1*Historic Contact Index+w2*Recent Contact Index], wherein w1 is the weightage assigned to the ‘Historic Contact Index’, and w2 is the weightage assigned to the ‘Recent Contact Index’. Further, sum of w1 and w2 may not be greater than 1.

The computing module 216 may further compute the payment index. The payment index may be computed based on a current payment amount for the customer account. The current payment amount denotes a current balance for a collection account of the customer. When the current payment amount is positive i.e. the current payment amount is greater than zero, the payment index may be ‘1’. Similarly, when the current payment amount is zero, or less than zero the payment index may be ‘0’.

Further, in another implementation of the system 102, a plurality of indices, apart from the payment index and the contact index, may be configured by the user. The recoverability index may be computed based on the plurality of indices. The system 102 enables addition, modification, or configuration of the plurality of indices by the user.

The system 102 further comprises the classifying module 218. The classifying module 218 classifies the customer account based on the recoverability index. The classifying module 218 classifies the customer account in a group based on a pre-defined range of the recoverability index. In an exemplary implementation, the group may be atleast one of most likely to pay, very likely to pay, likely to pay, quite unlikely to pay, and unlikely to pay.

TABLE 2

| | Pre-defined Range of | |
|---|---|---|
| Sr. No. | Recoverability Index (Indicative) | Group |
| 1 | 0.1-0.2 | unlikely to pay |
| 2 | 0.2-0.4 | quite unlikely to pay |
| 3 | 0.4-0.6 | likely to pay |
| 4 | 0.6-0.8 | very likely to pay |
| 5 | 0.9-1.0 | most likely to pay |

In an exemplary implementation of the system 102, Table 2 illustrates the plurality of groups formed according to the pre-defined ranges of the recoverability index. When the recoverability index is between 0.1-0.2, the customer is unlikely to pay the outstanding amount. Similarly, when the recoverability index is between 0.2-0.4, the customer is quite unlikely to pay the outstanding amount. Further, when the recoverability index is between 0.4-0.6, the customer is likely to pay the outstanding amount.

Similarly, when the recoverability index is between 0.6-0.8, the customer is very likely to pay the outstanding amount, and when the recoverability index is between 0.9-1.0, the customer is most likely to pay the outstanding amount. The pre-defined range of the recoverability index may be configured by the user. The user may also modify the pre-defined range of the recoverability index.

The classification of plurality of customer accounts into plurality of groups is based on the contact index as well as the recoverability index. As the classification takes into account both contact index and the recoverability index, the classification is more accurate and precise. Further, the classification of the plurality of the customer accounts enables recovery agents or the collection agents to target the customer accounts which are likely to pay, likely to pay, or most likely to pay. The classification of the plurality of customer accounts also enables identification of most profitable customers from the plurality of the customer accounts. Thus, the classification may also help in prioritizing collection activities for the customer accounts which have highest recovery potential, thereby reducing operation costs involved in the collection activities.

The system 102 further comprises the displaying module 222. The displaying module 222 displays the plurality of customer accounts based on the classification of the plurality of customer accounts into the plurality of groups.

The system 102 further comprises the validating module 220. The validating module validates the predictive data model by leveraging data points of the contact index and the payment index around precision, sensitivity, specificity, and accuracy. The precision, the sensitivity, the specificity, and the accuracy may be computed using values of the contact index and the payment index around True Positives (TP), True Negatives (TN), False Positives (FP), and False Negatives (FN) when the model gets built using the historical data.

The precision may be computed as, precision=(#TP/(# TP+# FP)). Similarly, the sensitivity may be computed as, sensitivity=(# TP/(# TP+# FN)). Further, the specificity may be computed as, specificity=(# TN/(# TN+# FP)). Also, the accuracy may be computed as, accuracy=((# TP+# TN)/(# TP+# TN+# FP+# FN)). TN for the contact index may be computed as, TN=IF (AND (Contact Index <0.5, Actual value=0), 1, 0). Similarly, TP for the contact index may be computed as, TP=IF (AND (Contact Index >0.5, Actual Value=1), 1, 0). FN for the contact index may be computed as, FN=IF (AND (Contact index <0.5, actual value=1), 1, 0). Further, FP for the contact index may be computed as, FP=IF (AND (Contact Index >0.5, Actual Value=0), 1, 0).

Further, TN for the payment index may be computed as, TN=IF (AND (payment index <0.5, actual value=0), 1, 0). Further, TP for the payment index may be computed as, TP=IF (AND (payment index >=0.5, actual value=1), 1, 0). Similarly, FN for the payment index may be computed as, FN=IF (AND (payment index <0.5, actual value=1), 1, 0). Further, FP may be computed as, FP=IF (AND (payment index >=0.5, actual value=0), 1, 0).

Further, by way of a specific example, consider that for a data set of 50 customer accounts, a count of TN for the contact index is 28. Similarly, for the data set, the count of TP for the contact index is 12, the count of FN for the contact index is 8, and the count of FP for the contact index is 8. Thus, the precision for the contact index may be computed as, precision=(#TP/(# TP+# FP)), i.e. precision=12*100/(12+8)=60. Further, sensitivity for the contact index may be computed as, sensitivity=(# TP/(# TP+# FN)), i.e. sensitivity=12*100/(12+8)=60. Also, specificity for the contact index may be computed as, specificity=(# TN/(# TN+# FP)), i.e. specificity=28*100/(28+8)=77.77. Further, accuracy for the contact index may be computed as, accuracy=((# TP+# TN)/(# TP+# TN+# FP+# FN)), i.e. accuracy=(12+28)/(28+12+8+8)=71.42.

Similarly, for the data set, consider that the count of TN for the payment index is 30. The count of TP for the payment index is 14, the count of FN for the payment index is 8, and the count of FP for the payment index is 7. Precision for the payment index may be computed as, precision=(#TP/(# TP+# FP)), i.e. precision=14*100/(14+7)=66.66. Further, sensitivity=(# TP/(# TP+# FN)), i.e. sensitivity=14*100/(14+8)=63.63. Also, specificity=(# TN/(# TN+# FP)), i.e. specificity=30*100/(30+7)=81.08. Similarly, accuracy=((# TP+# TN)/(# TP+# TN+# FP+# FN)), i.e. accuracy=(30+14)/(30+14+8+7).

Further, the user may discard the predictive data model based on the accuracy and the precision after a series of predictions if the accuracy and the precision do not increase while validating predictive data the model. Similarly, users may also retain the predictive data model if there is gain in the accuracy and the precision while validating the predictive model.

In one implementation of the system 102, if the values of precision, sensitivity, specificity, and accuracy are below pre-defined threshold values, the predictive data model may be rebuilt using the historical data to compute the values of the contact index, payment index. The recoverability index may be computed, based on the contact index and the payment index, when values of precision, sensitivity, specificity, and accuracy for contact index and the payment index meet a pre-defined threshold value. Thus, the predictive data model may be built multiple times until the predictive data model is actually used.

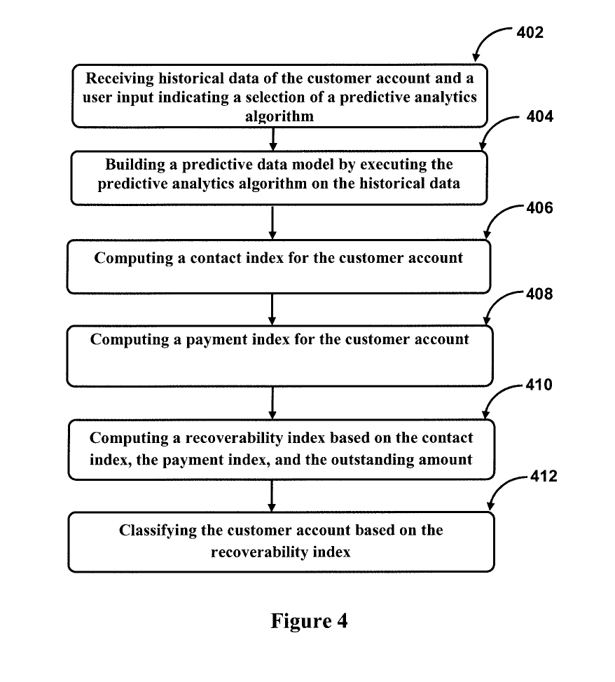

Referring now to FIG. 4, a method 400 for classifying a plurality of customer accounts based on a recoverable amount from a customer account is shown, in accordance with an embodiment of the present subject matter. The method 400 may be described in the general context of computer executable instructions. Generally, computer executable instructions can include routines, programs, objects, components, data structures, procedures, modules, functions, etc., that perform particular functions or implement particular abstract data types. The method 400 may also be practiced in a distributed computing environment where functions are performed by remote processing devices that are linked through a communications network. In a distributed computing environment, computer executable instructions may be located in both local and remote computer storage media, including memory storage devices.

The order in which the method 400 is described is not intended to be construed as a limitation, and any number of the described method blocks can be combined in any order to implement the method 400 or alternate methods. Additionally, individual blocks may be deleted from the method 400 without departing from the spirit and scope of the subject matter described herein. Furthermore, the method can be implemented in its suitable hardware, software, firmware, or combination thereof. However, for ease of explanation, in the embodiments described below, the method 400 may be considered to be implemented in the above described system 102.

At block 402, historical data of the customer account and a user input indicating a selection of a predictive analytics algorithm may be received. In one implementation, the historical data of the customer account and a user input indicating a selection of a predictive analytics algorithm may be received by the receiving module 212.

At block 404, a predictive data model may be built by executing the predictive analytics algorithm on the historical data. In one implementation, the predictive data model may be built by the building module 214.

At block 406, a contact index for the customer account may be computed. The contact index denotes a probability of an accountholder of the customer account getting contacted by a user. In one implementation, the contact index for the customer account may be computed by the computing module 216.

At block 408, a payment index for the customer account may be computed. The payment index denotes the probability of the account holder paying the recoverable amount from an outstanding amount of the customer account. In one implementation, the payment index for the customer account may be computed by the computing module 218.

At block 410, a recoverability index may be computed based on the contact index, the payment index, and the outstanding amount. In one implementation, the recoverability index for the customer account may be computed by the computing module 218.

At block 412, the customer account may be classified based on the recoverability index. In one implementation, the customer account may be classified by the classifying module 220.

Although implementations for methods and systems for classifying a plurality of customer accounts based on a recoverable amount from a customer account have been described in language specific to structural features and/or methods, it is to be understood that the appended claims are not necessarily limited to the specific features or methods described. Rather, the specific features and methods are disclosed as examples of implementations for classifying a plurality of customer accounts based on a recoverable amount from a customer account.

We claim:

1. A method for classifying a plurality of customer accounts based on a recoverable amount from a customer account of the plurality of customer accounts, the method comprising:
receiving, by a processor, historical data of the customer account and a user input indicating a selection of a predictive analytics algorithm from a set of predictive analytics algorithms;
building, by the processor, a predictive data model by executing the predictive analytics algorithm on the historical data, the building comprising:
computing a contact index for the customer account, wherein the contact index denotes a probability of an accountholder of the customer account getting contacted by a user;
computing a payment index for the customer account, wherein the payment index denotes the probability of the account holder paying the recoverable amount from an outstanding amount of the customer account; and
computing a recoverability index based on the contact index, the payment index, and the outstanding amount, wherein the recoverability index denotes the recoverable amount; and
classifying, by the processor, the customer account based on the recoverability index.

2. The method of claim 1, further comprising validating the predictive data model based on a precision, sensitivity, specificity, and accuracy, wherein the precision, sensitivity, specificity, and accuracy is computed based on the contact index and the payment index.

3. The method of claim 1, wherein the historical data comprises collection data for the customer account.

4. The method of claim 1, wherein the user input further comprises a data field selected from a set of data fields, wherein the set of data fields capture data of the account holder.

5. The method of claim 4, wherein the set of data fields comprises gender, age, address, locality, occupation, employment, marital status, income, home phone, and mobile phone.

6. The method of claim 4, further comprising receiving a value or a value range, and weightage for the data field to build the predictive data model.

7. The method of claim 1, further comprising displaying the plurality of customer accounts based on classification of the plurality of customer accounts into a plurality of groups.

8. The method of claim 7, wherein a group of the plurality of groups is formed based on a predefined range of the recoverability index.

9. The method of claim 1, wherein the set of predictive analytics algorithm comprises a supervisory algorithm and a non-supervisory algorithm.

10. A system for classifying a plurality of customer accounts based on a recoverable amount from a customer account of the plurality of customer accounts, the system comprising:
a processor; and
a memory coupled to the processor, wherein the processor is capable of executing a plurality of modules stored in the memory, and wherein the plurality of modules comprising:
a receiving module to receive historical data of the customer account and a user input indicating a selection of a predictive analytics algorithm from a set of predictive analytics algorithms;
a building module to build a predictive data model by executing the predictive analytics algorithm on the historical data, the building module further comprising a computing module to compute,
a contact index for the customer account, wherein the contact index denotes a probability of an account holder of the customer account getting contacted by a user;
a payment index for the customer account, wherein the payment index denotes the probability of the account holder paying the recoverable amount from an outstanding amount of the customer account; and
a recoverability index based on the contact index, the payment index, and the outstanding amount, wherein the recoverability index denotes the recoverable amount; and
a classifying module to classify the customer account based on the recoverability index.

11. The system of claim 10, further comprising a validating module to validate the predictive data model based on a precision, sensitivity, specificity, and accuracy, wherein the precision, sensitivity, specificity, and accuracy is computed based on the contact index and the payment index.

12. The system of claim 10, wherein the historical data comprises collection data for the customer account.

13. The system of claim 10, wherein the user input further comprises a data field selected from a set of data fields, wherein the set of data fields capture data of the account holder.

14. The system of claim 13, wherein the set of data fields comprises gender, age, address, locality, occupation, employment, marital status, income, home phone, and mobile phone.

15. The system of claim 13, wherein the receiving module further receives a value or a value range, and weightage for the data field to build the predictive data model.

16. The system of claim 10, further comprising a displaying module to display the plurality of customer accounts based on classification of the plurality of customer accounts into a plurality of groups.

17. The system of claim 16, wherein a group of the plurality of groups is formed based on a predefined range of the recoverability index.

18. The system of claim 10, wherein the set of predictive analytics algorithm comprises a supervisory algorithm, and a non-supervisory algorithm.

19. A non-transitory computer readable medium embodying a program executable in a computing device for classifying a plurality of customer accounts based on a recoverable amount from a customer account of the plurality of customer accounts, the program comprising:
a program code for receiving historical data of the customer account and a user input indicating a selection of a predictive analytics algorithm from a set of predictive analytics algorithms;
a program code for building a predictive data model by executing the predictive analytics algorithm on the historical data, the program code for building comprising:
a program code for computing a contact index for the customer account, wherein the contact index denotes a probability of an accountholder of the customer account getting contacted by a user;
a program code for computing a payment index for the customer account, wherein the payment index denotes the probability of the account holder paying the recoverable amount from an outstanding amount of the customer account; and
a program code for computing a recoverability index based on the contact index, the payment index, and the outstanding amount, wherein the recoverability index denotes the recoverable amount; and
a program code for classifying the customer account based on the recoverability index.
